(19) United States
(12) Patent Application Publication
(10) Pub. No.: US 2014/0365276 A1
(43) Pub. Date: Dec. 11, 2014

(54) DATA-DRIVEN INVENTORY AND REVENUE OPTIMIZATION FOR UNCERTAIN DEMAND DRIVEN BY MULTIPLE FACTORS

(71) Applicant: International Business Machines Corporation, Armonk, NY (US)

(72) Inventors: Pavithra Harsha, Yorktown Heights, NY (US); Ramesh Natarajan, Pleasantville, NY (US); Dharmashankar Subramanian, White Plains, NY (US)

(73) Assignee: International Business Machines Corporation, Armonk, NY (US)

(21) Appl. No.: 14/033,497

(22) Filed: Sep. 22, 2013

Related U.S. Application Data
(60) Provisional application No. 61/831,263, filed on Jun. 5, 2013.

(51) Int. Cl. G06Q 10/06; G06Q 30/02

(52) U.S. Cl. CPC G06Q 10/06315; G06Q 30/0202
USPC 705/7.31

(57) ABSTRACT

Based on a time series history of a random variable representing demand for at least one of a good and a service as a function of at least one controllable demand driver, obtain a quantile regression function that estimates a quantile of a demand distribution function; obtain a mixed- and/or super-quantile regression function that estimates conditional value at risk; and obtain a regression function that estimates mean of the demand distribution function. Joint optimization of: inventory of the at least one of a good and a service, and the at least one controllable demand driver, is undertaken based on the quantile regression function and the mixed- and/or super-quantile regression function, to obtain an optimal value for the at least one controllable demand driver and an implied optimal value for a stocking level. One or more exogenous demand drivers can optionally be taken into account.

### CROSS-REFERENCE TO RELATED APPLICATIONS

This application claims the benefit of U.S. Provisional Application No. 61/831,263 filed on Jun. 5, 2013, which is hereby expressly incorporated herein by reference in its entirety (including its appendix) for all purposes.

### STATEMENT OF GOVERNMENT RIGHTS

This invention was made with Government support under Contract No.: DE-OE0000190 awarded by the Department of Energy. The Government has certain rights in this invention.

### FIELD OF THE INVENTION

The present invention relates to the electrical, electronic and computer arts, and, more particularly, to analytical and optimization techniques, and the like.

### BACKGROUND OF THE INVENTION

The classical price-setting newsvendor problem in inventory theory is primarily concerned with the joint determination of the optimal order quantity and price level to maximize expected profitability for a price-dependent stochastic demand during a single period. This problem, along with its many variants, has been widely studied in the literature, but most if not all of the results pertain to the case when the stochastic price-demand relationship is known in some simple and explicit form. The results are widely used in decision support and revenue optimization in many applications areas including but not limited to retail, transportation, hospitality, disaster management and energy.

### SUMMARY OF THE INVENTION

Principles of the invention provide techniques for data-driven inventory and revenue optimization for uncertain demand driven by multiple factors. In one aspect, an exemplary method includes the steps of obtaining access to a time series history of a random variable representing demand for at least one of a good and a service as a function of at least one controllable demand driver; carrying out quantile regression based on the time series history to obtain a quantile regression function that estimates a quantile of a demand distribution function as a function of the at least one controllable demand driver; carrying out at least one of mixed-quantile regression and super-quantile regression based on the time series history to obtain at least a corresponding one of a mixed-quantile regression function and a super-quantile regression function that estimates conditional value at risk corresponding to the quantile of the demand distribution function, as a function of the at least one controllable demand driver; and carrying out mean regression based on the time series history to obtain a regression function that estimates mean of the demand distribution function as a function of the at least one controllable demand driver. A further step includes carrying out joint optimization of: inventory of the at least one of a good and a service, and the at least one controllable demand driver, based on the quantile regression function, and the at least corresponding one of a mixed-quantile regression function and a super-quantile regression function, to obtain an optimal value for the at least one controllable demand driver and an implied optimal value for a stocking level for the at least one of a good and a service.

Optionally, one or more exogenous demand drivers are also taken into account.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments may provide one or more of the following advantages:
The ability to jointly optimize for the inventory order quantity as well as the price in order to obtain better solution to the revenue optimization even in situations where the price-demand relationship has a complex relationship that includes multiple pricing and exogenous factors.
A new approach to incorporate data-driven modeling of the complex demand relationship on multiple factors, and to estimating the parameters in these complex models, which are incorporated into the framework that addresses the optimal solution of the price-setting newsvendor problem.
The use of distribution-free methods for the errors in the demand relationship on multiple factors, which enable the optimal solution of the price-setting problem to be obtained with few if any assumptions on the form of this error distribution.
The use of novel data-driven methods which directly estimate the quantities of interest, such as the Value-at-Risk and the Conditional Value-at-Risk from the price-demand relationship for the solution of the optimization problem in the price-sensitive newsvendor setting, for which more accurate methods are available that are not affected by the possibly irrelevant “global” behavior of the price-demand relationship.
The incorporation and estimation of heteroscedasticity in the price-demand relationship, which is a pervasive feature of real-world applications, but is rarely taken into account in the optimal solution of the price-sensitive newsvendor problem.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows a first algorithm, in accordance with an aspect of the invention;

FIG. 2 shows a second algorithm, in accordance with an aspect of the invention;

FIG. 3 shows a first, quantile regression, step, in accordance with an aspect of the invention;

FIG. 4 shows a second, mixed-quantile or super-quantile regression, step, in accordance with an aspect of the invention;

FIG. 5 shows a third, mean regression, step, in accordance with an aspect of the invention;

FIG. 6 shows a fourth, profit optimization, step, in accordance with an aspect of the invention;

FIG. 7 shows exemplary combination of the first through fourth steps, in accordance with an aspect of the invention;

FIG. 8 shows a data-driven approach exemplary schematic, including a quantile regression, superquantile regression, and mean regression in accordance with an aspect of the invention;

FIG. 9 shows data-driven approach exemplary schematic, including an iterative re-weighted least squares with generalized linear model exemplary schematic, in accordance with an aspect of the invention;

FIG. 10 depicts a computer system that may be useful in implementing one or more aspects and/or elements of the invention; and

FIG. 11 shows an exemplary application to an electrical power grid, in accordance with an aspect of the invention.

### DETAILED DESCRIPTION OF PREFERRED EMBODIMENTS

As noted, the classical price-setting newsvendor problem in inventory theory is primarily concerned with the joint determination of the optimal order quantity and price level to maximize expected profitability for a price-dependent stochastic demand during a single period. This problem, along with its many variants, has been widely studied in the literature, but most of the results pertain to the case when the stochastic price-demand relationship is known in some simple and explicit form. In many practical situations, however, the stochastic price-demand relationship is not known, and must be modeled from historical demand data, and except in simple cases, the appropriate demand distributions have a complex multivariate dependence on many variables besides price. This case has not been addressed in the literature. Advantageously, one or more embodiments provide two data-driven methods that allow a flexible modeling of the price-demand relationship: the first is based on heteroscedastic linear regression, and the second is based on heteroscedastic quantile and super-quantile regression. Illustrative, non-limiting computational details are provided for each technique herein, using simulated examples. The sensitivity of the resulting optimal solution to model estimation errors is examined.

The price-setting newsvendor problem, along with its many variants, is a central problem in the coordinated pricing and inventory literature. In its simplest form, a decision maker must determine the optimal price and optimal order quantity in order to maximize the expected profit during a single period, given a price-sensitive stochastic demand and given the associated overage and underage costs.

In practical applications, the appropriate form of the stochastic price-demand relationship may not be explicitly known and in many cases, the appropriate model structure and the model parameters may need to be estimated from historical price-demand data. One or more embodiments advantageously provide a flexible approach for modeling the price-demand relationship in the data-driven case, wherein it is no longer necessary to restrict the class of models to those for which the deterministic and stochastic components are specified in some explicit form.

One or more embodiments use a data-driven, regression based methodology for ascertaining the appropriate price-demand model, include additional covariate effects in the modeling framework, and/or treat model estimation errors on the sensitivity and accuracy of the optimization problem.

One non-limiting exemplary application of one or more embodiments is the application of the price-setting newsvendor problem to demand response schemes in the emerging electricity smart grid. An electric utility can provision its generation and procurement requirements on the supply side, as well as provide a demand-shaping price-incentive signal on the demand side, in order to manage its overall operational objectives, which may include minimizing the costs of generation, spinning reserve and excess-power salvage, and minimizing revenue shortfalls due to any changes in consumption, while simultaneously satisfying the requirements for the stochastic responsive demand. In this smart grid application, weather and time-of-day effects play significant roles in modifying the price-demand response and demand variability, and should be taken into account in the optimization problem.

The non-limiting exemplary application to demand response in the smart grid is used as a didactic aid to motivate and describe significant aspects of one or more embodiments. A person having ordinary skill in the art will recognize that this motivation and description, inter alia, can be used in a variety of other application domains, some of which are subsequently referenced here; all of these exemplary applications may be regarded as special cases of the general price-sensitive newsvendor problem.

For further simplicity, the non-limiting exemplary description is described for the case of the single-period pricing and inventory optimization problem, known as the emergency order setting (another alternative to the emergency order setting is the lost sales setting; a person having ordinary skill in the art will recognize the straightforward application of one or more embodiments of the present invention to the lost sales setting as well). For a description of the differences between the emergency order and lost sales settings, reference is made to the survey by Chen, X. and D. Simchi-Levi, 2008, Pricing and inventory management, Oxford Handbook of Pricing Management, Oxford University Press, Oxford, UK.

To describe the single-period, emergency order setting for the price-setting newsvendor problem in the demand response application for the smart grid, consider an electric utility that charges its consumers a price pεP for every unit of electricity they consume where P is the set of feasible prices, which is assumed to be a closed set (a closed set is defined as a set that contains all limit points; this condition ensures that the sequence of values to the solution of the optimal price problem from this set also converges to a value within the set; for instance any finite union of closed intervals on the real line is a closed set). Depending on the price signal p, the aggregate consumer demand is a random variable D(p,z) that is controlled by price p, as well as by other external exogenous factors z such as weather, time-of-day and various other factors such as special events or holidays. The firm aims to satisfy all the aggregate consumer demand using conventional electricity generation and/or spinning reserves. Conventional generation has to be pre-ordered and has a constant marginal cost c whereas spinning reserves can be deployed instantaneously and hence more expensive because they always have to be in standby mode. Because demand is a random variable, any excess demand above the conventional generation is satisfied using spinning reserves at a cost m>c and any excess generation is salvaged at a price s. The utility aims to maximize its expected profitability by jointly making decisions on the price p and the order quantity x from conventional generation. This problem can be formulated as follows:

$$Π ( z ) \text{:} {max}_{p ∈ P , x} pE [ D ( p , z ) ] - cx - {mE [ D ( p , z ) - x ]}^{+} + {sE [ x - D ( p , z ) ]}^{+} \qquad ( 1 )$$

The commonly studied price-sensitive newsvendor formulation is a lost-sales model where any excess demand above the stocking inventory is lost (i.e., m=p, a decision variable). One or more embodiments employ a price-sensitive newsvendor model with an emergency ordering capability where the excess demand is satisfied by the market at a high but constant cost, m.

The objective of problem Π(z), is a concave function in x for a given p and the solution of the newsvendor problem has the following form:

$${x}^{*} ( p , z ) = inf \{ x \geq 0 \text{:} {F}_{D ( p , z )} ( X ) \geq α = \frac{m - c}{m - s} \} . \qquad ( 2 )$$

where F_{D(p,z)}(.) is the cumulative distribution function (c.d.f.) of the random variable D(p,z). Here, α is known as a critical quantile and x*(p,z) as the value-at-risk of the random variable D(p,z) denoted in short as VaR_{α}(D(p,z)). Substituting x*(p,z), the problem can be reduced to:

$$Π ( z ) \text{:} {max}_{p ∈ P} ( p - s ) E [ D ( p , z ) ] - ( c - s ) {CVaR}_{α} ( D ( p , z ) ) \qquad ( 3 )$$

where CVaR_{α}(Y) is the conditional value-at-risk of the random variable Y defined as follows:

$${CVaR}_{α} ( Y ) = {min}_{x} [ x + \frac{1}{( 1 - α )} {E [ Y - x ]}^{+} ] \qquad ( 4 )$$

CVaR is a risk measure and well known in the literature; it is also referred to equivalently in the prior art as the average value-at-risk, mean excess loss and mean shortfall. More specifically, in electricity demand, there is a widely-used reliability metric termed loss of load in expectation (LOLE) which is closely related to the CVaR. One or more embodiments provide a data driven approach to compute the optimal order quantity and price and provide some theoretical guarantees on the quality of the solution.

Two non-limiting exemplary embodiments are described below. Both of these are based on a data-driven approach that takes into account the potentiality of multiple factors and heteroscedasticiy in the problem formulation.

### First Exemplary Approach Based on Homoscedastic and Heteroscedastic Regression

Traditional data driven methods using least squares regression for any stochastic optimization problem, including the price-sensitive newsvendor problem, involve the following steps: (1) an assumption on the structure of the dependence of the random variable (in this case, the demand) on the explanatory variables (in this case, the demand drivers) that is referred to herein as the generating model, (2) least squares based regression-based method to retrieve all the parameters of the generating model, and (3) stochastic optimization using the estimated parameters and the residuals noise vector to obtain the decision variables (in this case, optimal price and order quantity).

Model Assumption:

For estimation using least squares regression, one significant assumption is that the mean of the response variable, Y, must be a linear combination of the regression coefficients, say β, and the predictive variables vector X, i.e., E[Y]=β^{T}X, where the vector X can include the constant 1 (reference is made to William Greene, Econometric Analysis, Prentice Hall 2011). For estimations beyond the mean functional, further assumptions are required on the structure of the generating model. More specifically, the generating model is assumed to be as follows:

Y=β^{T}X+h(γ^{T}X)ε (5)

where ε is a random variable whose distribution is independent of X such that E[ε]=0 and h(.) is a known monotonic function. This model is referred to as a homoscedastic if h(γ^{T}X) is a constant that is independent of X (with a default of 1), and heteroscedastic otherwise.

In one or more embodiments, Y is a known (monotonic) function of demand and X is a vector of known functions of demand drivers such as price and other exogenous uncontrollable factors such as weather. The linear dependence on coefficients and basis functions in Equation (5) does not preclude the use of complex basis functions that incorporate non-linear transformations of the demand drivers. The commonly used demand model is the additive-multiplicative model where D(p)=f(p)+g(p)ε, where f(p) and g(p) are deterministic functions and ε is a random variable whose distribution is independent of p and such that E[ε]=0. Depending on the choice of functions f and g, the model can be estimated using the least squares regression method. For example, suppose f(p) and g(p) are linear functions; then,

$$Y = D ( p )$$

$$and$$

$$X = ( \begin{matrix}1 \\ p\end{matrix} ) .$$

For other examples involving more general parametric functions of the demand, perform a monotonic transformation to reduce the demand function to the standard form. For example, suppose D(p)=ae^{-bp}ε where E[ε]=1; take the natural logarithmic transformation which results in log D(p)=log a−bp+log ε. Then defining Y=log D(p) and

$$X = ( \begin{matrix}1 \\ p\end{matrix} )$$

reduces it to the standard form in Equation (5).

Model Estimation:

The goal of the estimation procedure is to use the data, which after any preliminary transformations is assumed to be given in the form {xᵢ, yᵢ}, i=1, . . . , N, to estimate the values of β and γ. The discussion of the estimation procedure is provided in the two cases, viz., the homoscedastic case and the heteroscedastic case.

If the model is homoscedastic, the preferred estimation method is ordinary linear least squares (OLS). The output is \hat{β} and a vector of the residuals \hat{ε}ᵢ. It is known from the Gauss-Markov theorem that this least squares estimate is the minimum-variance, unbiased estimator, and that it is also a strongly consistent (the Gauss-Markov theorem is described in many introductory books in econometrics, e.g., Greene, William, 2011, Econometric Analysis. Prentice Hall; a strongly consistent estimator approaches its true value almost surely, i.e., with probability 1, as the sample size n of the data goes to infinity). Since the OLS estimator is optimal for any demand distribution, qualify this method as a data-driven and distribution-free methodology.

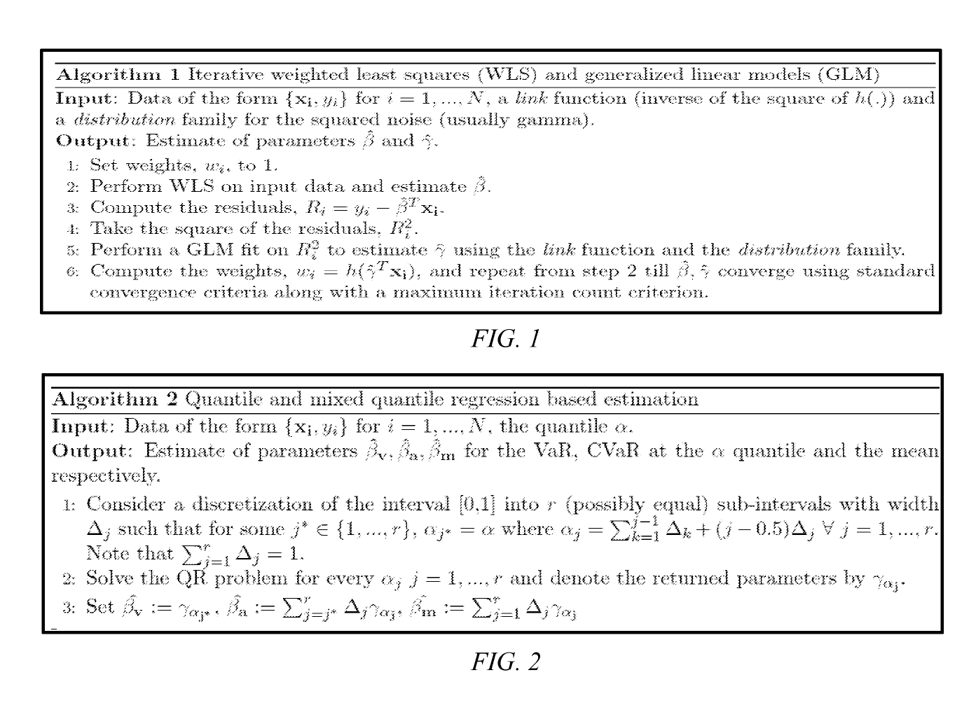

In the presence of heteroscedasticity, although the OLS method continues to give consistent estimators, the preferred method is weighted least squares (WLS) which, in addition to consistency, provides the appropriate minimum-variance unbiased estimator in this case. For the WLS, the weights h(γ^{T}X) are required part of the input to the procedure; however these weights are unknown, and in turn also have to be estimated. Thus, a systematic data-driven method to estimate these weights as well as the coefficients in the mean regression is the iterative WLS and generalized linear models (GLM) method. This algorithm is set forth in FIG. 1. See Gordon K. Smyth, A. Frederik Huele, Arunas P. Verbyla, Exact and approximate reml for heteroscedastic regression, Statistical modeling 1(3) 161-175 (2001).

The GLM procedure is a generalization of the OLS methodology to estimate unknown linear functions that are embedded within known non-linear functions. In the FIG. 1 algorithm, the GLM method works with the square of the residuals (R²) and in particular because E[R²]=Variance(R²)+E²[R]=h²(γ^{T}X), the method can estimate γ for a known h(.) function. The GLM method requires two additional inputs compared to the OLS method, a link function and a distribution family A link function corresponds to the inverse of the known non-linear function. In one or more embodiments, working with the square of the residuals, the link function is the square root function if h(.) is the identity function and is the log if h(.) is the exponential function. The distribution family in the GLM fit corresponds to the distribution that the squared residuals are assumed to belong to. In commercially available GLM packages such as those in R or MATLAB, the distribution family is expressed using a known parametric distribution and usually, a distribution in the exponential family. In the iterative methodology with WLS, the preferred distribution is usually a gamma distribution. This is because if it is assumed that ε˜N(0,1) (i.e., the unit normal distribution with mean 0 and standard deviation 1), then R²˜χ² (i.e., the Chi-squared distribution for some known f, where f is the number of degrees of freedom)—the Chi-squared distribution is also a special case of the gamma distribution. Because of the assumption of the distribution family, although the method is data-driven in this case, it does not qualify as being distribution-free, although one or more embodiments include a modification that qualifies as being distribution-free as described next.

Optimization:

To obtain the decision variables of the optimization problem, first obtain the empirical or data-based estimates for the VaR and CVaR of ε from the residual noise vector \hat{ε} where:

$${\hat{ε}}_{i} = \frac{{y}_{i} - {\hat{β}}^{T} {x}_{i}}{h ( {\hat{γ}}^{T} {x}_{i} )} . \qquad ( 6 )$$

Note that since it is desired to develop a distribution-free methodology, opt for this procedure over the one that computes these quantities with the distribution that was assumed for the GLM fit routine. Denote the empirical cdf of εᵢ as:

$${F}_{\hat{ε}} ( u ) = \frac{1}{N} {\sum }_{i = 1}^{N} {[ {\hat{ε}}_{i} \leq u ]}_{} \qquad ( 7 )$$

where [symbol] [.] is the indicator function which takes the value 1 if the argument is true and zero otherwise. Then:

VaRₒ(\hat{ε})=inf{u:Fᵢ(u)≧α},and (8)

CVaRₒ(\hat{ε})λ_{α}(\hat{ε})VaR_{α}(\hat{ε})+(1−λ_{α}(\hat{ε}))E[\hat{ε}|\hat{ε}>VaR_{α}(\hat{ε})] (9)

where:

$${λ}_{α} ( \hat{ε} ) = \frac{{F}_{\hat{ε}} ( {VaR}_{α} ( \hat{ε} ) ) - α}{1 - α} . \qquad ( 10 )$$

Note that if the raw data was monotonically transformed to arrive at a linear predictor for the purpose of estimation, the inverse transformations have to be performed prior to the CVaR computation as VaR is preserved under monotonic transformation but CVaR is not. Now, substituting CVaR and VaR in Eq. (3) and Eq. (2) and solving the price optimization problem, immediately gives the optimal price, and order quantity {p*(z),x*(z)}, as a function of the other covariates.

For example, if Y=D(p) and

$$X = ( \begin{matrix}1 \\ p\end{matrix} ) ,$$

obtain:

$$\begin{matrix}{p}^{*} = arg {min}_{p ∈ P} ( p - s ) {\hat{β}}_{m}^{T} ( \begin{matrix}1 \\ p\end{matrix} ) - ( c - s ) [ {\hat{β}}^{T} ( \begin{matrix}1 \\ p\end{matrix} ) + h ( {\hat{γ}}^{T} ( \begin{matrix}1 \\ p\end{matrix} ) ) {CVaR}_{α} ( \hat{ε} ) ] & ( 11 ) \\ {x}^{*} = {\hat{β}}^{T} ( \begin{matrix}1 \\ {p}^{*}\end{matrix} ) + h ( {\hat{γ}}^{T} ( \begin{matrix}1 \\ {p}^{*}\end{matrix} ) ) {VaR}_{α} ( \hat{ε} ) & ( 12 )\end{matrix}$$

The optimization problem in Eq. (23) is a convex optimization problem as long as h(.) is a convex function. In particular, if h(.) is linear it is a simple quadratic optimization problem whose solution can be written in closed form depending on the set P.

Summary:

Under a homoscedastic setting, the approach is a data-driven distribution free approach that results in consistent parameter estimates. On the other hand, in a heteroscedastic setting, GLM subroutine requires the specification of the entire generation model and a parametric distributional assumption on the error. Hence, the iterative WLS-GLM procedure results in inconsistent and sub-optimal, estimators when the true distribution is different from the assumed distribution. The convergence issues that are occasionally encountered in the iterative procedure for obtaining the parameter estimates may also be consideration when comparing this exemplary approach with the second exemplary approach described below.

### Second Exemplary Approach Based on Quantile and Mixed Quantile Regression

One or more embodiments provide a data-driven distribution free method tailored to the price-sensitive newsvendor problem. In this method, the quantities of interest (VaR, CVaR and the mean) used in the optimization problem are directly estimated, thereby integrating estimation and optimization. The steps involved in the proposed method are as follows: (1) assumptions on structure of the model for the quantities of interest, (2) quantile and mixed-quantile and/or superquantile regression methods to retrieve the parameters on interest and (3) optimization to obtain the optimal price and order quantity. Aside from deriving the mixed quantile regression method for heteroscedastic distributions, different regression methods are integrated to solve the price-sensitive newsvendor problem.

Model Assumption:

In quantile and mixed quantile (or superquantile) regression, (as is in the case of least squares regression) the response variable of interest, here the VaR or CVaR of the response variable Y at a certain specified quantile, is a linear combination of the regression coefficients and the predictive variables X. Generally denote the desired quantile as α, where α is real-valued in the closed interval [0,1]), Then:

VaR_{α}(Y)=βᵥ^{T}XCVaR_{α}(Y)=β_{c}^{T}X (13)

where X can also include a column with the constant 1 (for the intercept term). The estimation for the mean of the variable Y, unless specified, can be considered as a special case of the CVaR estimation problem at the α=0 quantile. This is because E[Y]=CVaR₀(Y) and therefore assume that E[Y]=β_{c}^{T} X as well.

As pointed out above, the linear forms are a result of various monotonic transformations of more complex functions of the demand, price and other covariates, in order to make these demand functions amenable to estimation procedures. Consider the most commonly used additive-multiplicative demand model D(p)=f(p)+g(p)ε, where f(p) and g(p) are deterministic functions and ε is a random variable whose distribution is independent of p and such that E[ε]=0. Suppose there exists a monotonic transformation that reduces it to the form Y=β^{T} X+γ^{T}X ε where Y is some known (monotonic) function of demand and X is a vector of known basis functions of demand drivers such as price and other exogenous uncontrollable factors such as weather. Then, VaR_{α}(Y)=VaR_{α}(ε)=(β+VaR_{α}(ε)γ)^{T}X=βᵥ^{T} X. A similar linear form also holds for the CVaR and the mean that E[Y] as well. In the absence of any monotonic transform, the linear form can be considered as a piece of the piecewise linear approximation of the demand function directly.

Note that because the underlying models do not assume a generating model, the class of demand models that can satisfy the above assumptions is much larger than the class of demand models that can be handled by the methods in the prior art. For example, this includes the class of all linear models in which the interaction between the covariates may take completely different forms at different levels of the quantile a. To vividly illustrate this point, a non-limiting example is provided below.

### Example 1

Consider the following model as an example:

Y=β^{T}X+γ₁^{T}Xmin{ε,λ}+γ₂^{T}Xmax{λ,ε} (14)

where ε is a random variable and λ is constant such that λ=VaR_{ζ}(ε) for some value ζε(0,1). This is a special case of a mixture model between two random variables ε₁ and ε₂ where ε₁=min {ε,λ) and ε₂=max {ε,λ). For this generating model:

$${VaR}_{α} ( Y ) = \{ \begin{matrix}{[ β + {γ}_{1} λ + {γ}_{2} {VaR}_{α} ( ε ) ]}^{T} X & α \geq ζ \\ {[ β + {γ}_{1} {VaR}_{α} ( ε ) + {γ}_{2} λ ]}^{T} X & α < ζ\end{matrix} \qquad ( 15 )$$

Observe the linear relationship between regression coefficients and the covariates X for the VaR. Similarly, a linear relationship can also be derived for CVaR and the mean using the following equations:

$$\begin{matrix}{CVaR}_{α} ( min \{ ε , λ \} ) = \{ \begin{matrix}λ & α \geq ζ \\ {CVaR}_{α} ( ε ) + ( λ - τ ) \frac{1 - ζ}{1 - α} & α < ζ\end{matrix} & ( 16 ) \\ {CVaR}_{α} ( max \{ ε , λ \} ) = \{ \begin{matrix}{CVaR}_{α} ( ε ) & α \geq ζ \\ \frac{ζ - α}{1 - α} λ + \frac{1 - ζ}{1 - α} τ & α < ζ\end{matrix} & ( 17 )\end{matrix}$$

where τ=CVaR_{ζ}(ε).

Model Estimation Using Quantile Regression and Mixed Quantile Regression:

First, quantile and mixed-quantile regression methods that estimate VaR_{α}(Y) and CVaR_{α}(Y) given α are described and derived. Then the superquantile regression is discussed as an alternate method to estimate CVaR_{α}(Y).

Quantile Regression:

Quantile regression is a method to estimate the conditional quantile of the response variable, Y, as a function of its predictor variables, X, given the quantile, α. Suppose VaR_{α}(Y)=β^{T}X for some β values. Solve the following optimization problem to estimate β*:

$$QR \text{:} {β}^{*} = arg {min}_{β} \frac{1}{N} {\sum }_{i = 1}^{N} {ψ}_{α} ( {y}_{i} - {β}^{T} {x}_{i} ) \qquad ( 18 )$$

where ψ_{θ}(t)=θ[t]⁺+(1−θ)[−t]⁺. The objective in the above formulation is to minimize the (quantile) weighted absolute error between the response variable and estimated function. The optimization problem can be rewritten as a linear programming problem and can be solved very efficiently. Note that a linear relationship of the response variable with the coefficients of the predictor variables is essential for the optimization problem to be a linear programming. This is because the objective involves both positive and negative components of the same quantity and hence any non-linear relationship will result in a non-convex problem. Quantile regression also results in consistent estimates (Koenker, Roger, Jr. Bassett, Gilbert. 1978. Regression quantiles. Econometrica 46(1) 33-50).

Mixed Quantile Regression:

Mixed quantile regression is one method to estimate the conditional CVaR of a response variable, Y, as a function of its predictor variables, X, for a given quantile a. One or more embodiments employ a linear programming formulation that is quite similar to quantile regression but outputs the conditional CVaR function. Some techniques in the prior art provide a consistent estimator for CVaR for a homoscedastic distribution only, whereas one or more embodiments allow for heteroscedasticity and generalize the linear programming model used in the prior art. The formulation for one of these embodiments will now be derived.

Consider a representation of CVaR in terms of VaR as follows:

$${CVaR}_{α} ( Y ) = \frac{1}{1 - α} {\int }_{α}^{1} {VaR}_{τ} ( Y ) d τ \qquad ( 19 )$$

View Σⱼ₌₁λⱼVaR_{α}_{ⱼ}(Y) as a discretization of the integral in Eq. (19) where Σⱼ₌₁^{r}λⱼ=1. Using this idea, now formulate the mixed quantile regression problem as a convex combination of several quantile regression problems. Consider the following optimization problem where:

$$\begin{matrix}Δ := \frac{1 - α}{r} , {λ}_{j} = {( 1 - α )}^{- 1} Δ \\ and \\ {α}_{j} := α + ( j - 0.5 ) Δ ∀ j = 1 , … r . & ( 20 ) \\ MQR \text{:} {β}_{c}^{*} = arg {min}_{β , {τ}_{j}} {\sum }_{j = 1}^{r} \frac{1}{N} {\sum }_{i = 1}^{N} {λ}_{j} {ψ}_{{α}_{j}} ( {y}_{i} - {( {τ}_{j} + β )}^{T} {x}_{i} ) & ( 21 ) \\ s . t . {\sum }_{j = 1}^{r} {λ}_{j} {τ}_{j} = 0 & ( 22 )\end{matrix}$$

where ψ_{θ}(t)=θ[t]⁺+(1−θ)[−t]⁺. The objective in the above formulation can be seen as the weighted sum of several quantile regression problems, one at each αⱼ. The corresponding conditional quantile function at αⱼ is (β+τⱼ)^{T}X. This, together with constraint (22), implies that β_{c}^{T} X is in fact the CVaR functional that it is desired to estimate. This formulation accounts for heteroscedasticity because any quantile functional that is estimated (e.g., (τⱼ+β)^{T}X at quantile level αj) need not be parallel to another quantile functional, which is a requirement for a homoscedastic model.

In the above formulation, all the quantile regression problems are solved simultaneously. As specified, the above formulation can be parallelized by solving multiple instances of quantile regression problems for quantiles ranging from α to 1, and then taking a convex combination of these, weighed by the corresponding discretization interval used. In some case, side constraints may be provided: these include conditions to ensure the non-crossing of quantile lines within the range of the data, or explicit imposition of homoscedasticity; these side conditions will then require the problem to be solved as a single combined optimization problem instead of multiple individual quantile regression problems.

Observe that this formulation has an inherent assumption that every VaR functional can be written as a linear combination of the regression coefficients and the basis functions. Note that this is not a restrictive assumption at all because the basis functions can always be extended so as to encompass a wide range of functions, with individual quantiles depending on corresponding individual sets of basis functions. With finite data, the quantile regression method is not guaranteed to preserve monotonicity across the quantile functionals across the range of the data, or in the certain region of the data of interest. In the homoscedastic case for the CVaR evaluation (where τⱼ can be set to a scalar), this issue does not arise, since all the quantile regressions are parallel lines that can always be re-ordered ex poste if necessary. However, in the heteroscedastic case, the quantile lines are bound to intersect by definition. To ensure that any such intersection occurs outside the region of the data of interest, certain monotonicity conditions can be imposed at the extreme points of the desired region of interest. These monotonicity conditions will not affect the consistency of the corresponding CVaR estimator as long as this region of interest is chosen appropriately.

The algorithm of FIG. 2 summarizes a combined estimation procedure that results in estimates for the VaR, CVaR and the mean. Note that if the sample data needed to be monotonically transformed to obtain a linear predictor for the purpose of estimation, then the inverse transformations have to be performed after step 2, prior to the CVaR estimation; this is because CVaR is not preserved under monotonic transformation. Also, observe since the estimators are at best consistent estimators (and therefore, may be biased), the OLS method (a data driven distribution free method) can be employed for just the mean estimation alone, which usually also results in a significant reduction in overall computational time for the method; this modified method is referred to herein as the hybrid approach.

Superquantile Regression:

An alternative method to the mixed-quantile regression is known as the superquantile regression. Superquantile regression estimates the CVaR functional of a random variable using a linear program more directly and naturally by extending quantile regression. A significant concept is the combination of the following two steps: (1) transforming the random variable into a different random variable whose quantile functionals are the superquantiles (or CVaR functionals) of the variable under consideration and (2) use quantile regression on this transformed variable. Reference is made to R.T. Rockafellar, J. O. Royset, and S. I. Miranda, Superquantile regression with applications to buffered reliability, uncertainty quantification, and conditional value-at-risk, Working Paper 2013. The Rockafellar reference is hereby expressly incorporated by reference herein in its entirety for all purposes One significant benefit of superquantile regression methodology is that there is no discretization error, as in the mixed quantile regression method described earlier herein; hence this methodology has fewer parameters that need to be specified in order to obtain the desired results. Moreover, because the basis for the superquantile regression is also a quantile regression method, the resulting superquantile estimators are also consistent. Nevertheless, superquantiles also have the same issues regarding the monotonicity for different values of a; different superquantiles may possibly intersect within the region of interest for the data.

There is potentially limitation to this approach that may arise in certain circumstances—this is that the CVaR is not preserved under monotonic transformations. Therefore, the response variable Y must be the demand itself, (and not some monotonic transformation of demand, as is often adopted for commonly used non-linear demand models in the prior art for the newsvendor problem, including the case for exponential and power demand models).

Optimization:

Substituting the estimates of the mean, CVaR and VaR in Eq. (3) and Eq. (2) and recalling Y=D(p) and

$$x = ( \begin{matrix}1 \\ p\end{matrix} ) ,$$

obtain:

$$\begin{matrix}{p}^{*} = arg {min}_{p ∈ P} ( p - s ) {\hat{β}}_{m}^{T} ( \begin{matrix}1 \\ p\end{matrix} ) - ( c - s ) [ {\hat{β}}_{a}^{T} ( \begin{matrix}1 \\ p\end{matrix} ) ] & ( 23 ) \\ {x}^{*} = {\hat{β}}_{v}^{T} ( \begin{matrix}1 \\ {p}^{*}\end{matrix} ) & ( 24 )\end{matrix}$$

The optimization problem in Eq. (23) is a simple quadratic optimization problem whose solution, depending on the set P, can be written in closed form.

One or more embodiments are completely data driven and distribution free. The estimation procedure results in consistent estimators of the VaR, CVaR and the mean. This in turn results in consistent estimates of the optimal price and optimal order quantity. The mixed-quantile estimation procedure relies on the discretized version of the integral in Eq. (19), which is clearly an approximation when dealing with finite data. However, in practice, any finer discretization beyond a certain point does not change or improve the quality of the VaR or CVaR estimator.

### Exemplary Method

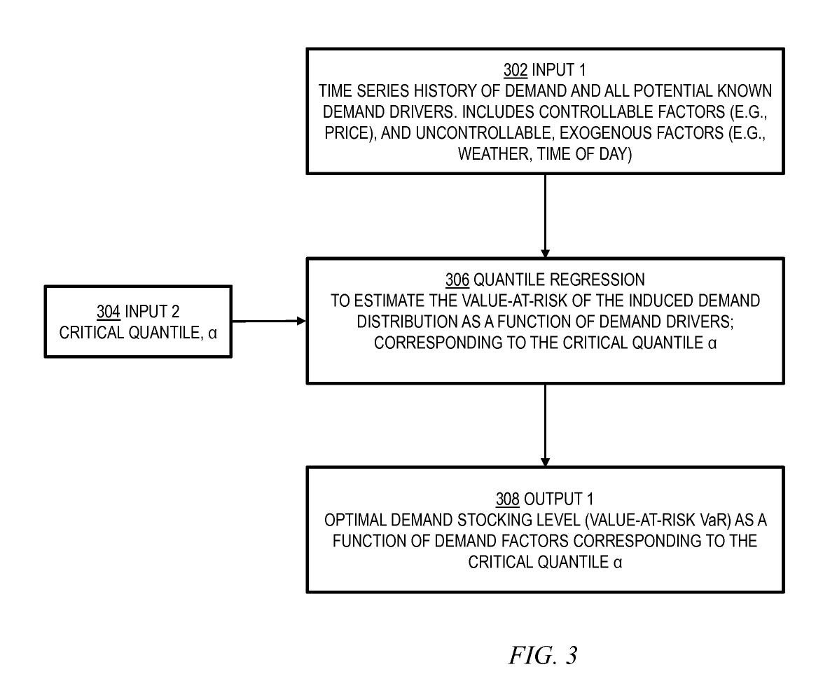

The block diagram of FIG. 3 describes the Quantile Regression step 306, which is used in one or more embodiments to estimate the quantile (i.e. Value-at-Risk) of the demand distribution as a regression function whose covariates are the various demand drivers that include controllable factors such as price, as well as exogenous (uncontrollable) factors such as weather-related variables, time-of-day, and so on. The quantile regression step takes the following inputs:
1. Time-series history 302 in the form of a time-indexed vector of demand, renewable generation, controllable demand drivers (e.g. price) and uncontrollable, external factors (e.g. weather-related variables, time-of-day)
2. As seen at 304, the critical quantile, α, is provided as input.

This step produces as output 308 a quantile regression function that estimates the α-quantile of the demand distribution function, as a function of controllable and uncontrollable demand drivers. This output, in the form of a regression function, provides the optimal demand stocking level, and further feeds into the joint price-inventory optimization formulation.

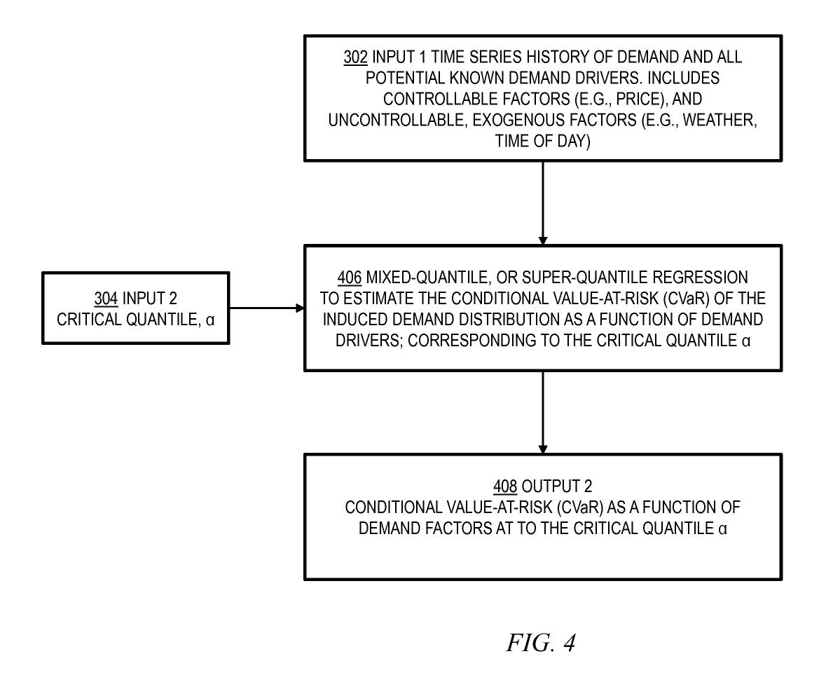

The block diagram of FIG. 4 describes either Mixed-Quantile regression, or alternatively Super-Quantile regression, 406, both of which provide a procedure (within the overall method) to estimate the Condition Value-at-Risk of the demand distribution as a regression function whose covariates are the various demand drivers that include controllable factors such as price, as well as external (uncontrollable) factors such as weather-related variables, time-of-day, and so on. The mixed-quantile regression (and likewise, the super-quantile regression) procedure takes the following inputs:
1. Time-series history 302 in the form of a time-indexed vector of demand, renewable generation, controllable demand drivers (e.g. price) and uncontrollable, external factors (e.g. weather-related variables, time-of-day)
2. As seen at 304, critical quantile α

This step produces as output 408 a mixed-quantile/super-quantile regression function that estimates the Conditional Value-at-Risk corresponding to the α-quantile of the demand distribution function, as a function of controllable and uncontrollable demand drivers. This output, in the form of a regression function, feeds into the joint price-inventory optimization formulation of the method.

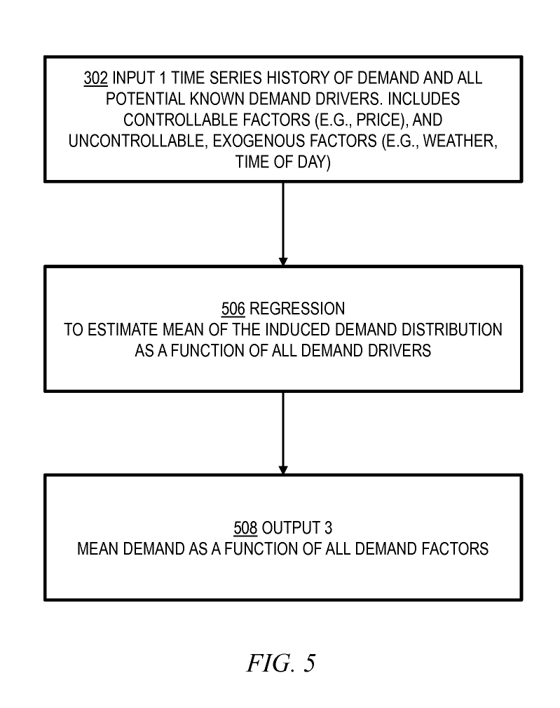

The block diagram of FIG. 5 describes the Mean Regression (say, using least squares regression) step 506, which is used in the method to estimate the mean of the demand distribution as a regression function whose covariates are the various demand drivers that include controllable factors such as price, as well as external (uncontrollable) factors such as weather-related variables, time-of-day, and so on. The mean regression step in the method takes the following inputs:
1. Time-series history 302 in the form of a time-indexed vector of demand, renewable generation, random variable controllable demand drivers (e.g. price) and uncontrollable, external factors (e.g. weather-related variables, time-of-day).

Step 506 produces as output 508 a regression function that estimates the mean of the demand distribution function, as a function of controllable and uncontrollable demand drivers. This output, in the form of a regression function, feeds into the joint price-inventory optimization formulation.

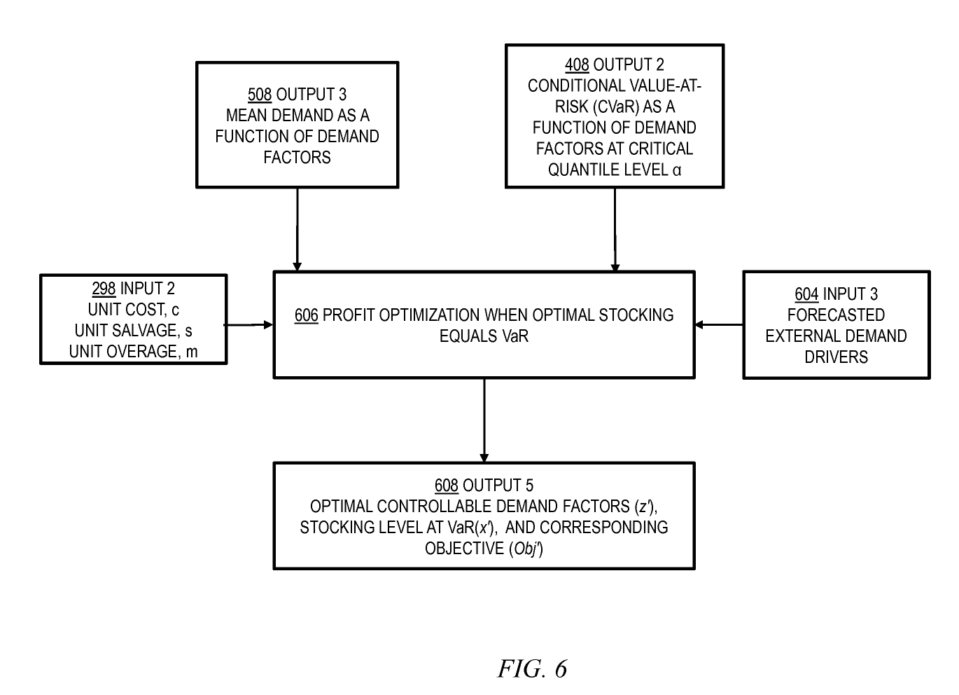

The block diagram of FIG. 6 describes the Profit optimization step 606, under the condition that the optimal stocking level is equal to the α quantile of the demand distribution function, which was estimated as a function of controllable and uncontrollable demand drivers in step 306. It takes as input:
1. The output 508 of Step 506, namely, a regression function that estimates the mean of the demand distribution function, as a function of controllable and uncontrollable demand drivers.
2. The output 408 of Step 406, namely, a regression function that estimates the Conditional Value-at-Risk corresponding to the α quantile of the demand distribution function, as a function of controllable and uncontrollable demand drivers.
3. Critical quantile α 304 and/or input 2 298 (unit cost c, unit salvage s, unit overage m)
4. Forecasted values for exogenous (uncontrollable) demand drivers as at 604

Step 606 produces as output 608 the corresponding optimal values for the controllable demand drivers. It also produces as an implied output the corresponding optimal stocking level, which may be obtained by substituting the above optimal values for the controllable demand drivers, along with the forecasted values for the exogenous (uncontrollable) demand drivers into the regression function from Step 306, namely, the regression function that estimates the α-quantile of the demand distribution function, as a function of controllable and uncontrollable demand drivers. It also produces as output the optimal profit that may be obtained through the above optimal solution for the controllable demand drivers.

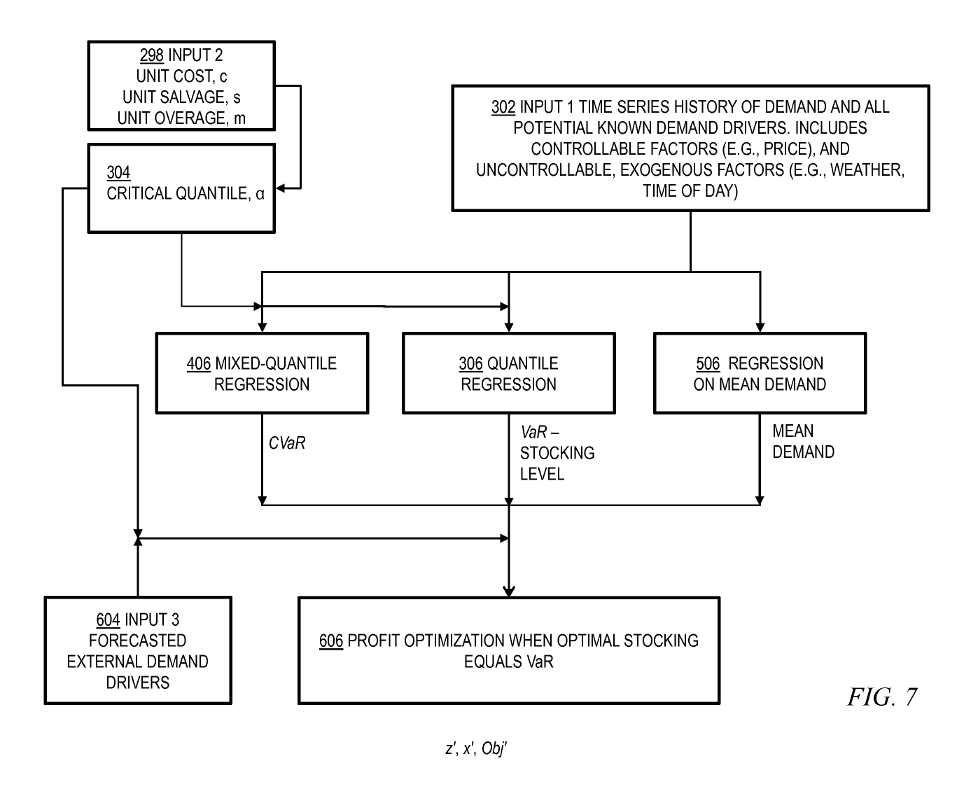

FIG. 7 shows the combination of each of the above Steps 306, 406, 506, 606 that come together to solve the data-driven joint price and inventory optimization problem for maximizing profitability. Each of the individual steps has been described above and this makes FIG. 7 self-explanatory.

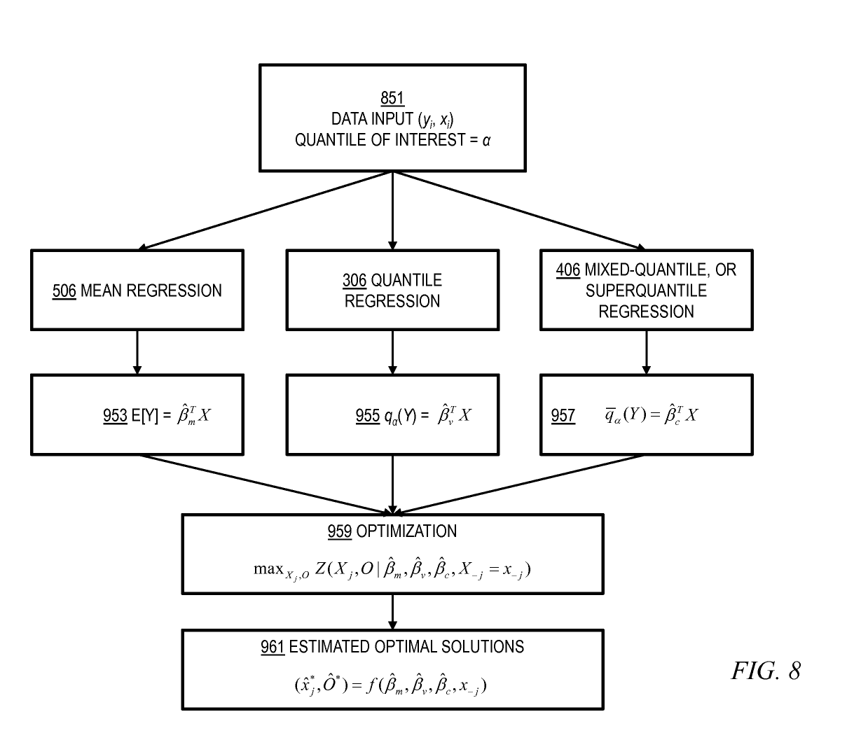

FIG. 8 shows an exemplary schematic of the overall procedure. The variable “X” denotes the vector of all controllable and uncontrollable demand drivers. The input data 851 (yᵢ, xᵢ) represents the i^{th} sample data point pair that contains the observed demand yᵢ corresponding to the demand driver vector xᵢ. The variable Y denotes the demand (random) variable. The quantile parameter of interest, namely, α quantile, is denoted for convenience as α.

The three estimation blocks 506, 306, 406 in the middle of the schematic show linear regression models, as an example for each of:
1. Mean Regression model (Step 506, or Least Squares Regression model, in relation to the block diagrams described previously),
2. Quantile Regression model (or Step 306, as previously described), and
3. Mixed-Quantile/Super-Quantile regression model (or Step 406, as previously described).

The estimated outputs for these linear regression models (i.e. linear in the covariates contained in the vector X) are the coefficients, namely, \hat{β}ₘ for the mean regression, \hat{β}ᵥ for the quantile regression and \hat{β}_{c} for the super-quantile regression. See 953, 955, 957.

These models in turn feed into the profit-optimization routine 959 that seeks to jointly optimize the stocking level (inventory) that is denoted with variable O, as well as the controllable demand drivers denoted as the variable Xⱼ. Note that the variable Xⱼ is a vector that contains the controllable subset of the demand drivers contained within X. Likewise, Xⱼ denotes a vector that contains the exogenous, uncontrollable subset of the demand drivers contained within X. Lastly, Xⱼ=x₋ⱼ denotes a specific forecasted value for the variable Xⱼ. The optimization solution 961, denoted as, (\hat{x}ⱼ*,Ô*) is a data-driven estimate of the optimal solution for the controllable demand drivers and the stocking level.

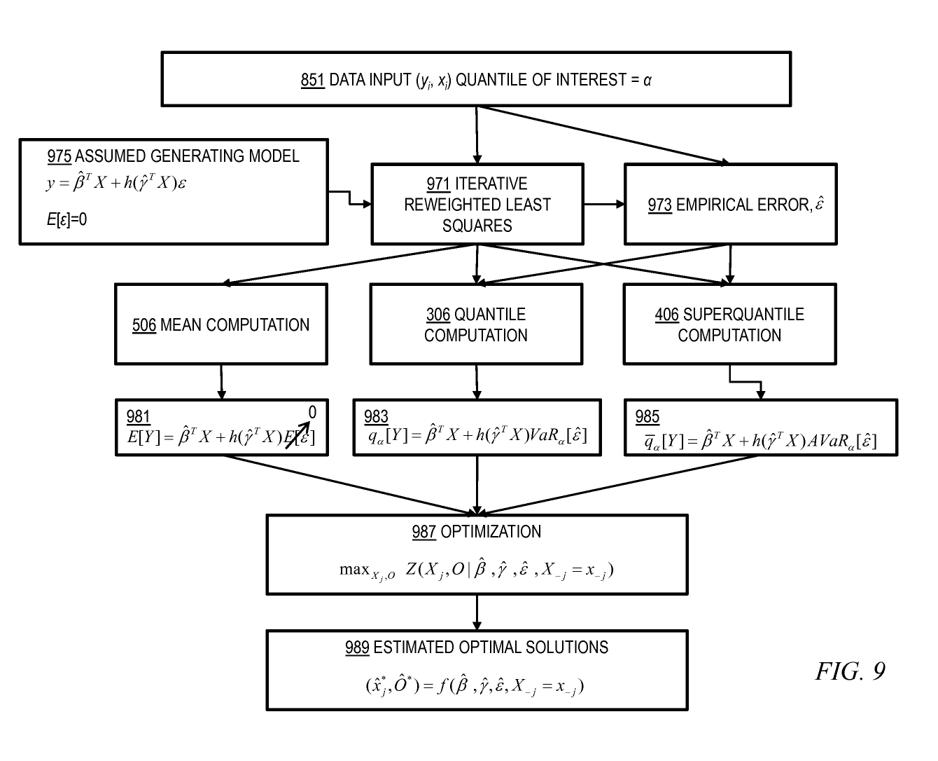

Under the “Assumed Generating Model” 975 shown in FIG. 9, the iterative reweighted least squares with generalized linear model (GLM) procedure 971 produces estimates for each of \hat{β}, \hat{γ}, \hat{ε}. The empirical residual distribution \hat{ε}, 973, is used to compute estimate of the quantile (VaR, or Value-at-Risk) and the super-quantile (CVaR, or Conditional Value-at-Risk) of the noise distribution ε in the assumed generating model. The optimization problem, its output and the rest of the notation has the same interpretation as in FIG. 8. That is to say, input 851 is similar to that discussed above; computations 506, 306, 406 and their outputs 981, 983, 985 are analogous to those described above; and the optimization and solution blocks 987, 989 are also analogous to 959, 961.

Thus, some embodiments provide method steps for performing revenue optimization and inventory optimization for perishable inventory with uncertain demand subject to multiple demand drivers (controllable factors i.e., price) and multiple market factors (uncontrollable factors i.e., weather, time-of-day, competitive prices). Some embodiments also provide a program storage device readable by a machine, tangibly embodying a program of instructions executable by the machine to perform the indicated method steps, and/or a memory, and at least one processor, coupled to the memory, and operative to perform the indicated method steps (for example, by loading into the memory code on the program storage device).

Some embodiments provide a data-driven model for estimating the uncertain demand distribution function as a function of empirical demand data, observed data values for the demand drivers, and market data factors. In some cases, the variance, skew and higher order distribution parameters can also be a function of demand drivers and market data factors. In some instances, the functions of interest in the profit optimization are directly or indirectly estimated using the above-mentioned data.

In some cases, a method based on the model(s), structures, and techniques discussed just above has the ability to estimate the revenue optimization for the optimal price in the presence of uncertain demand, even for values of the demand drivers and market factors not present in the observed data.

In some cases, a method based on the model(s), structures, and techniques discussed just above has the ability to perform the inventory optimization for the optimal stocking quantity in the presence of uncertain demand, even for values of the demand drivers and market factors not present in the observed data.

In some cases, a method based on the model(s), structures, and techniques discussed just above is provided for jointly performing the inventory optimization and the revenue optimization for operational decision support by a one-shot or by a sequential alternating procedure.

In some cases, in any of the methods, models, or techniques, in the estimates of the optimal order quantity, controllable variables and the objective function are provided along with confidence intervals.

One or more embodiments thus address the case where demand for a good or service is a function of both (i) variables that can be controlled or controllable demand drivers (e.g., price) and (ii) variables that cannot be controlled or uncontrollable or exogenous demand drivers (e.g., weather, time of day). One or more embodiments jointly optimize the stocking level and controllable demand drivers for an upcoming period for which estimates of the exogenous demand drivers are available. The dependency of demand on both the controllable and uncontrollable demand drivers should be understood before attempting to solve the optimization problem.

In one or more embodiments, historical data is accessed in the form of a time series including a plurality of tuples; one value of each tuple is the demand and the remaining values are the controllable and uncontrollable demand drivers. One or more embodiments model the demand as a random variable. The term “random variable” is used herein in its normal sense, i.e., a random variable or stochastic variable is defined as a variable whose value is subject to variations due to chance (i.e. randomness, in a mathematical sense)—as opposed to other mathematical variables, a random variable conceptually does not have a single, fixed value (even if unknown); rather, it can take on a set of possible different values, each with an associated probability. The probability distribution function of the demand is influenced by the controllable and uncontrollable demand drivers. Significant quantities include: (1) the mean value of the demand distribution as a function of the demand drivers, (2) the quantile of the demand distribution as a function of the demand drivers, and (3) the super-quantile of the demand distribution as a function of the demand drivers.

One or more embodiments can be employed in many different applications, such as power generation, airline reservations, and the like.

Turning attention again to FIG. 8, in one or more embodiments, the blocks can be implemented by distinct software modules. For example, in block 851, yᵢ is demand or some function of the demand, and xᵢ are all the demand drivers. One or more embodiments solve Eq. (1). The quantile of interest, α, is also an input; see Eq. (2). A database program is a non-limiting example of a technique to implement data access 851. Any kind of data structure or file structure can be used; with an actual data store and code to carry out queries. For example, SQL or other database queries could be used, or custom code could be written in a suitable language. Spreadsheets such as Excel or the like are another option. The code providing this functionality, whether a database or one or more alternative techniques, is referred to herein as a “data access module.” Block 306 can be implemented by a distinct software module including code that solves Eq. (18)—e.g., using any software that has an optimization solver for example, CPLEX, Gurobi, Matlab, R and the same for all the remaining techniques of the blocks below.

It is worth noting that one or more embodiments represent the objective function, through re-formulation, in terms of three quantities, the mean, the super-quantile, and the quantile. See Eq. (3).

Block 406 can be implemented by a distinct software module including code that solves Eq. (21) subject to (22). Block 506 can be implemented by a distinct software module including code that solves Eq. (21) subject to (22), with α=0. Blocks 506, 306, 406 respectively yield the three quantities 953, 955, 957, which are then used in the optimization process 959. Block 959 can be implemented by a distinct software module including code that solves Eq. (3) with substitution back into Eq. (2).

Turning attention again to FIG. 9, in one or more embodiments, the blocks can be implemented by distinct software modules. For example, in block 851, yᵢ is demand or some function of the demand, and xᵢ are all the demand drivers. One or more embodiments solve Eq. (1). The quantile of interest, α, is also an input; see Eq. (2). As noted above, a database program is a non-limiting example of a technique to implement data access 851. Any kind of data structure or file structure can be used; with an actual data store and code to carry out queries. For example, SQL or other database queries could be used, or custom code could be written in a suitable language. Spreadsheets such as Excel or the like are another option. Block 971 can be implemented by a distinct software module including code that implements the algorithm of FIG. 1. The output of block 971 includes \hat{β}, \hat{γ}, \hat{ε}. Block 306 can be implemented by a distinct software module including code that employs the equation (8) for VaR_{α}(\hat{ε}). Block 406 can be implemented by a distinct software module including code that solves Eq. (9). Block 987 can be implemented by a distinct software module including code that employs the outputs 981, 983, 985 of 506, 306, 406 to solve Eqs. (3) and (2).

Given the discussion thus far, it will be appreciated that, in general terms, an exemplary method, according to an aspect of the invention, includes the step 302 of obtaining access to a time series history of a random variable representing demand for at least one of a good and a service as a function of at least one controllable demand driver. A further step 306 includes carrying out quantile regression based on the time series history to obtain a quantile regression function that estimates a quantile of a demand distribution function as a function of the at least one controllable demand driver. Note that an α quantile is the quantity q_{α} associate with a random variable X such that the Prob{X<q_{α}}≦α. An even further step 406 includes carrying out at least one of mixed-quantile regression and super-quantile regression based on the time series history to obtain at least a corresponding one of a mixed-quantile regression function and a super-quantile regression function that estimates conditional value at risk corresponding to the quantile of the demand distribution function, as a function of the at least one controllable demand driver.

A still further step 506 includes carrying out mean regression based on the time series history to obtain a regression function that estimates mean of the demand distribution function as a function of the at least one controllable demand driver. Note that in one or more embodiments, this is mixed or super quantile regression at the 0th quantiles or could be OLS. Yet a further step 606 includes carrying out joint optimization of (1) inventory of the at least one of a good and a service, and (2) the at least one controllable demand driver, based on the quantile regression function, and the at least corresponding one of a mixed-quantile regression function and a super-quantile regression function, to obtain an optimal value for the at least one controllable demand driver and an implied optimal value for a stocking level for the at least one of a good and a service. Step 306 results are used in one or more embodiments because block 606 is the profit optimization when the stocking level equals the VaR. In one or more embodiments, solve this profit optimization problem for the optimal controllable driver and then substitute it in Step 306 to obtain the optimal stocking level at the value of the optimal controllable driver. Refer also to step 606 to obtain 608 using 959, 987 to obtain 961, 989.

In some cases, in the obtaining step, the random variable is further a function of at least one exogenous demand driver; in the step of carrying out the quantile regression, the quantile regression function that estimates the quantile of the demand distribution function further estimates same as a function of the at least one exogenous demand driver; in the step of carrying out the at least one of mixed-quantile regression and super-quantile regression, the corresponding one of a mixed-quantile regression function and a super-quantile regression function that estimates the conditional value at risk further estimates same as a function of the at least one exogenous demand driver; in the step of carrying out the mean regression, the regression function that estimates the mean further estimates same as a function of the at least one exogenous demand driver; and in the step of carrying out the joint optimization, same is further based on a forecast of the at least one exogenous demand driver (see 604).

In some instances, the quantile regression, the at least one of mixed-quantile regression and super-quantile regression, and the mean regression are carried out independently; and optionally in parallel.

At least some embodiments further include (see input 2 block 304) obtaining access to an estimate for critical quantile (α), wherein the quantile regression, the at least one of mixed-quantile regression and super-quantile regression, and the joint optimization are further based on unit cost, unit overage cost, and salvage; and the quantile of the demand distribution function includes a critical quantile.

It is worth noting that one or more embodiments extend to the case of lost sales where the overage cost is the decision variable price itself.

Some embodiments further include specifying the stocking level for the at least one of a good and a service, and the at least one controllable demand driver, for a time period corresponding to the forecast, in accordance with the optimal value for the at least one controllable demand driver and the implied optimal value for the stocking level for the at least one of a good and a service.

In a non-limiting example, the at least one of a good and a service includes electrical power, the at least one controllable demand driver includes price for the electrical power, and the at least one exogenous demand driver (where present and taken into account) includes ambient temperature in a region served by a provider of the electrical power.

In another aspect, the at least one of a good and a service includes at least one of a time-bound retail commodity and a perishable retail commodity, the at least one controllable demand driver includes price for the at least one of a time-bound retail commodity and a perishable retail commodity, and the at least one exogenous demand driver (where present and taken into account) includes at least one of advertising and weather effects which modify demand for the at least one of a time-bound retail commodity and a perishable retail commodity.

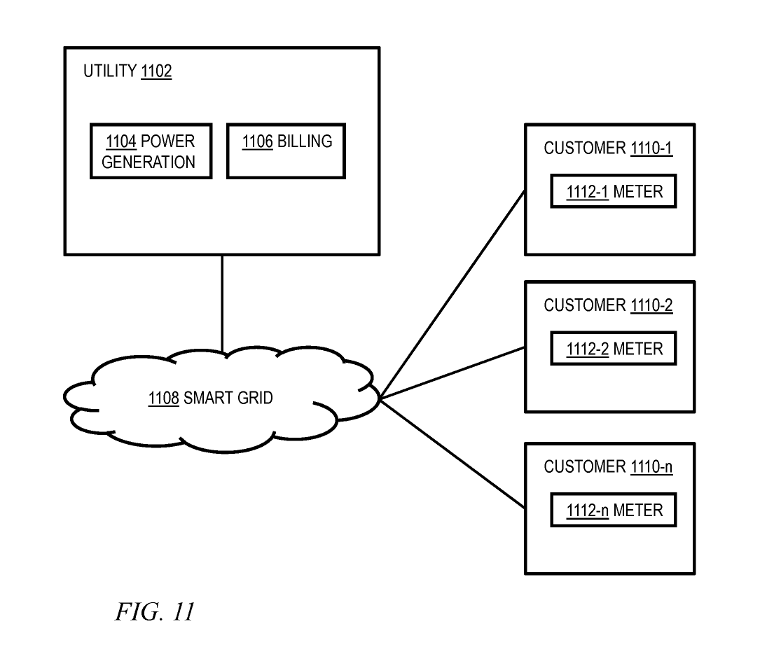

One or more embodiments have a variety of practical applications producing concrete and tangible results. Consider the system of FIG. 11. An electric utility 1102 carries out power generation with one or more generating plants 1104. The utility also has one or more servers or other computers 1106 used for billing. The utility is coupled to one or more consumers 1110-1, 1110-2, . . . , 1110-n, via a “smart grid” 1108. Note that a smart grid is discussed further below; note also that a smart grid is a non-limiting example and a conventional grid can also be employed. Each customer 1110 has a meter 1112-1, 1112-2, . . . , 1112-n. Billing computer 1106 bills each customer 1110 at the rate determined by one or more embodiments, for a given time period. The billing is based on readings of meters 1112 for the time period of interest.

A so-called smart grid includes a network of integrated microgrids that can monitor and heal itself. Offices, homes, and other buildings may include solar panels. Smart appliances can shut off in response to frequency fluctuations. Via demand management, use can be shifted to off-peak times to save money. Processors can execute special protection schemes in microseconds. Sensors detect fluctuations and disturbances, and can signal for areas (microgrid(s)) to be isolated. Energy generated at off-peak times can be stored in batteries for later use. Energy from small generators and solar panels (e.g., at industrial plants) can reduce overall demand on the grid. Wind farms and other alternative energy sources can be employed. The microgrid includes electrical power transmission lines, and optionally data connectivity for sensors, between meters 1112 and billing computer 1106, and so on. In other instances, data connectivity between meters 1112 and billing computer 1106 is provided by a separate network or even by traditional meters readers.

One or more embodiments can function with a smart grid or conventional grid, and can utilize any appropriate data connectivity between meters 1112 and billing computer 1106.

One or more embodiments further include providing a system, wherein the system includes distinct software modules. Each of the distinct software modules is embodied on a computer-readable storage medium, and the distinct software modules include a data access module, a quantile regression module, a mixed-super-quantile regression module, a mean regression module, and a joint optimization module. In such cases, the obtaining of the access to the time series history is carried out by the data access module executing on at least one hardware processor; the quantile regression is carried out by the quantile regression module executing on the at least one hardware processor; the at least one of mixed-quantile regression and super-quantile regression is carried out by the mixed-super-quantile regression module executing on the at least one hardware processor; the mean regression is carried out by the mean regression module executing on the at least one hardware processor; and the joint optimization is carried out by the joint optimization module executing on the at least one hardware processor.

Referring again to FIG. 9, in some cases, carry out an iterative reweighted least squares procedure on the time series history, as at 971, based on a generalized linear model 975, to obtain an estimate of the regression coefficients and the empirical error distribution. In such cases, carrying out of quantile computation is further based on the estimate of the regression coefficients and the empirical error distribution; carrying out at least one of mixed-quantile and super-quantile computation is further based on the estimate of the regression coefficients and the empirical error distribution; and carrying out of the mean computation is further based on the estimate of the regression coefficients.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

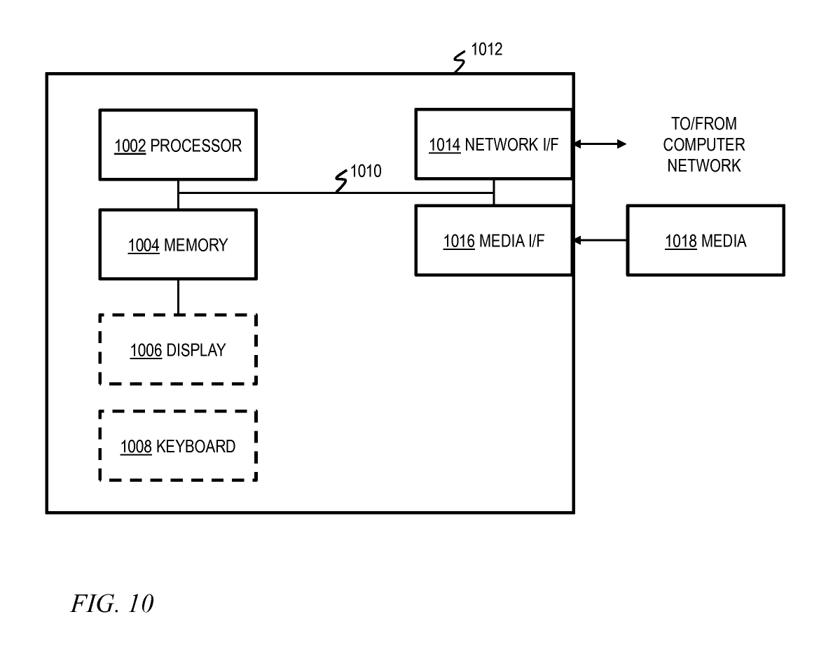

One or more embodiments can make use of software running on a general purpose computer or workstation. With reference to FIG. 10, such an implementation might employ, for example, a processor 1002, a memory 1004, and an input/output interface formed, for example, by a display 1006 and a keyboard 1008. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 1002, memory 1004, and input/output interface such as display 1006 and keyboard 1008 can be interconnected, for example, via bus 1010 as part of a data processing unit 1012. Suitable interconnections, for example via bus 1010, can also be provided to a network interface 1014, such as a network card, which can be provided to interface with a computer network, and to a media interface 1016, such as a diskette or CD-ROM drive, which can be provided to interface with media 1018.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 1002 coupled directly or indirectly to memory elements 1004 through a system bus 1010. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 1008, displays 1006, pointing devices, and the like) can be coupled to the system either directly (such as via bus 1010) or through intervening I/O controllers (omitted for clarity).

Network adapters such as network interface 1014 may also be coupled to the system to enable the data processing system to become coupled to other data processing systems or remote printers or storage devices through intervening private or public networks. Modems, cable modem and Ethernet cards are just a few of the currently available types of network adapters. A network adapter or other suitable port or the like can be used, for example, to obtain data from meters 1112 discussed elsewhere herein.

As used herein, including the claims, a “server” includes a physical data processing system (for example, system 1012 as shown in FIG. 10) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 1018 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a data access module, a quantile regression module, a mixed-super-quantile regression module (carries out mixed and/or super quantile regression), a mean regression module, and a joint optimization module. The method steps can then be carried out using the distinct software modules and/or sub-modules of the system, as described above, executing on one or more hardware processors 1002. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining access to a time series history of a random variable representing demand for at least one of a good and a service as a function of at least one controllable demand driver;
carrying out quantile regression based on said time series history to obtain a quantile regression function that estimates a quantile of a demand distribution function as a function of said at least one controllable demand driver;
carrying out at least one of mixed-quantile regression and super-quantile regression based on said time series history to obtain at least a corresponding one of a mixed-quantile regression function and a super-quantile regression function that estimates conditional value at risk corresponding to said quantile of said demand distribution function, as a function of said at least one controllable demand driver;
carrying out mean regression based on said time series history to obtain a regression function that estimates mean of said demand distribution function as a function of said at least one controllable demand driver; and
carrying out joint optimization of:
inventory of said at least one of a good and a service, and
said at least one controllable demand driver,
based on said quantile regression function, and said at least corresponding one of a mixed-quantile regression function and a super-quantile regression function, to obtain an optimal value for said at least one controllable demand driver and an implied optimal value for a stocking level for said at least one of a good and a service.

2. The method of claim 1, wherein:
in said obtaining step, said random variable is further a function of at least one exogenous demand driver;
in said step of carrying out said quantile regression, said quantile regression function that estimates said quantile of said demand distribution function further estimates same as a function of said at least one exogenous demand driver;
in said step of carrying out said at least one of mixed-quantile regression and super-quantile regression, said corresponding one of a mixed-quantile regression function and a super-quantile regression function that estimates said conditional value at risk further estimates same as a function of said at least one exogenous demand driver;
in said step of carrying out said mean regression, said regression function that estimates said mean further estimates same as a function of said at least one exogenous demand driver; and
in said step of carrying out said joint optimization, same is further based on a forecast of said at least one exogenous demand driver

3. The method of claim 2, wherein said quantile regression, said at least one of mixed-quantile regression and super-quantile regression, and said mean regression are carried out independently.

4. The method of claim 3, wherein said quantile regression, said at least one of mixed-quantile regression and super-quantile regression, and said mean regression are carried out in parallel.

5. The method of claim 2, further comprising obtaining access to an estimate for critical quantile, wherein:
said quantile regression, said at least one of mixed-quantile regression and super-quantile regression, and said joint optimization are further based on unit cost, unit overage cost, and salvage; and
said quantile of said demand distribution function comprises a critical quantile.

6. The method of claim 2, further comprising specifying said stocking level for said at least one of a good and a service, and said at least one controllable demand driver, for a time period corresponding to said forecast, in accordance with said optimal value for said at least one controllable demand driver and said implied optimal value for said stocking level for said at least one of a good and a service.

7. The method of claim 2, wherein said at least one of a good and a service comprises electrical power, said at least one controllable demand driver comprises price for said electrical power, and said at least one exogenous demand driver comprises ambient temperature in a region served by a provider of said electrical power.

8. The method of claim 2, wherein said at least one of a good and a service comprises at least one of a time-bound retail commodity and a perishable retail commodity, said at least one controllable demand driver comprises price for said at least one of a time-bound retail commodity and a perishable retail commodity, and said at least one exogenous demand driver comprises at least one of advertising and weather effects which modify demand for said at least one of a time-bound retail commodity and a perishable retail commodity.

9. The method of claim 2, further comprising providing a system, wherein the system comprises distinct software modules, each of the distinct software modules being embodied on a computer-readable storage medium, and wherein the distinct software modules comprise a data access module, a quantile regression module, a mixed-super-quantile regression module, a mean regression module, and a joint optimization module;
wherein:
said obtaining of said access to said time series history is carried out by said data access module executing on at least one hardware processor
said quantile regression is carried out by said quantile regression module executing on said at least one hardware processor;
said at least one of mixed-quantile regression and super-quantile regression is carried out by said mixed-super-quantile regression module executing on said at least one hardware processor;
said mean regression is carried out by said mean regression module executing on said at least one hardware processor; and
said joint optimization is carried out by said joint optimization module executing on said at least one hardware processor.

10. An apparatus comprising:
a memory; and
at least one processor, coupled to said memory, and operative to:
obtain access to a time series history of a random variable representing demand for at least one of a good and a service as a function of at least one controllable demand driver;
carry out quantile regression based on said time series history to obtain a quantile regression function that estimates a quantile of a demand distribution function as a function of said at least one controllable demand driver;
carry out at least one of mixed-quantile regression and super-quantile regression based on said time series history to obtain at least a corresponding one of a mixed-quantile regression function and a super-quantile regression function that estimates conditional value at risk corresponding to said quantile of said demand distribution function, as a function of said at least one controllable demand driver;
carry out mean regression based on said time series history to obtain a regression function that estimates mean of said demand distribution function as a function of said at least one controllable demand driver; and
carry out joint optimization of:
inventory of said at least one of a good and a service, and
said at least one controllable demand driver,
based on said quantile regression function, and said at least corresponding one of a mixed-quantile regression function and a super-quantile regression function, to obtain an optimal value for said at least one controllable demand driver and an implied optimal value for a stocking level for said at least one of a good and a service.

11. The apparatus of claim 10, wherein:
said random variable is further a function of at least one exogenous demand driver;
said quantile regression function that estimates said quantile of said demand distribution function further estimates same as a function of said at least one exogenous demand driver;
said corresponding one of a mixed-quantile regression function and a super-quantile regression function that estimates said conditional value at risk further estimates same as a function of said at least one exogenous demand driver;
said regression function that estimates said mean further estimates same as a function of said at least one exogenous demand driver; and
said joint optimization is further based on a forecast of said at least one exogenous demand driver.

12. The apparatus of claim 11, wherein said quantile regression, said at least one of mixed-quantile regression and super-quantile regression, and said mean regression are carried out independently.

13. The apparatus of claim 12, wherein said quantile regression, said at least one of mixed-quantile regression and super-quantile regression, and said mean regression are carried out in parallel.

14. The apparatus of claim 11, wherein said at least one processor is further operative to obtain access to an estimate for critical quantile, wherein:
said quantile regression, said at least one of mixed-quantile regression and super-quantile regression, and said joint optimization are further based on unit cost, unit overage cost, and salvage; and
said quantile of said demand distribution function comprises a critical quantile.

15. The apparatus of claim 11, wherein said at least one processor is further operative to specify said stocking level for said at least one of a good and a service, and said at least one controllable demand driver, for a time period corresponding to said forecast, in accordance with said optimal value for said at least one controllable demand driver and said implied optimal value for said stocking level for said at least one of a good and a service.

16. The apparatus of claim 11, wherein said at least one of a good and a service comprises electrical power, said at least one controllable demand driver comprises price for said electrical power, and said at least one exogenous demand driver comprises ambient temperature in a region served by a provider of said electrical power.

17. The apparatus of claim 11, wherein said at least one of a good and a service comprises at least one of a time-bound retail commodity and a perishable retail commodity, said at least one controllable demand driver comprises price for said at least one of a time-bound retail commodity and a perishable retail commodity, and said at least one exogenous demand driver comprises at least one of advertising and weather effects which modify demand for said at least one of a time-bound retail commodity and a perishable retail commodity.

18. The apparatus of claim 11, further comprising a plurality of distinct software modules, each of the distinct software modules being embodied on a computer-readable storage medium, and wherein the distinct software modules comprise a data access module, a quantile regression module, a mixed-super-quantile regression module, a mean regression module, and a joint optimization module;
wherein:
said at least one processor is operative to obtain said access to said time series history by executing said data access module;
said at least one processor is operative to carry out said quantile regression by executing said quantile regression module;
said at least one processor is operative to carry out said at least one of mixed-quantile regression and super-quantile regression by executing said mixed-super-quantile regression module;
said at least one processor is operative to carry out said mean regression by executing said mean regression module; and
said at least one processor is operative to carry out said joint optimization by executing said joint optimization module.

19. A computer program product comprising a computer readable storage medium having computer readable program code embodied therewith, said computer readable program code comprising:
computer readable program code configured to obtain access to a time series history of a random variable representing demand for at least one of a good and a service as a function of at least one controllable demand driver;
computer readable program code configured to carry out quantile regression based on said time series history to obtain a quantile regression function that estimates a quantile of a demand distribution function as a function of said at least one controllable demand driver;
computer readable program code configured to carry out at least one of mixed-quantile regression and super-quantile regression based on said time series history to obtain at least a corresponding one of a mixed-quantile regression function and a super-quantile regression function that estimates conditional value at risk corresponding to said quantile of said demand distribution function, as a function of said at least one controllable demand driver;
computer readable program code configured to carry out mean regression based on said time series history to obtain a regression function that estimates mean of said demand distribution function as a function of said at least one controllable demand driver; and
computer readable program code configured to carry out joint optimization of:
inventory of said at least one of a good and a service, and
said at least one controllable demand driver,
based on said quantile regression function, and said at least corresponding one of a mixed-quantile regression function and a super-quantile regression function, to obtain an optimal value for said at least one controllable demand driver and an implied optimal value for a stocking level for said at least one of a good and a service.

20. The computer program product of claim 19, wherein:
said random variable is further a function of at least one exogenous demand driver;
said quantile regression function that estimates said quantile of said demand distribution function further estimates same as a function of said at least one exogenous demand driver;
said corresponding one of a mixed-quantile regression function and a super-quantile regression function that estimates said conditional value at risk further estimates same as a function of said at least one exogenous demand driver;
said regression function that estimates said mean further estimates same as a function of said at least one exogenous demand driver; and
said joint optimization is further based on a forecast of said at least one exogenous demand driver.
